(19) United States
(12) Patent Application Publication
(10) Pub. No.: US 2026/0156427 A1
(43) Pub. Date: Jun. 4, 2026

(54) Inserting External Communications During Inactive Periods Of A Channel In 3D Audio Space Providing Directional Audio

(71) Applicant: Sony Interactive Entertainment Inc., Tokyo (JP)

(72) Inventor: Ivy S. Tsai, San Mateo, CA (US)

(73) Assignee: Sony Interactive Entertainment Inc., Tokyo (JP)

(21) Appl. No.: 19/405,872

(22) Filed: Dec. 2, 2025

Related U.S. Application Data
(60) Provisional application No. 63/727,618, filed on Dec. 3, 2024.

(51) Int. Cl. H04S 7/00; A63F 13/54; G06F 3/16

(52) U.S. Cl. CPC H04S 7/30; A63F 13/54; G06F 3/165

(57) ABSTRACT

A method includes defining a three dimensional (3D) audio space having one or more audio sources configured to provide directional audio in the 3D audio space. The method includes receiving gaming audio from a game play of a video game of a player for presentation within the 3D audio space and assigning one or more source locations in the 3D audio space to the one or more audio sources. The method includes projecting audio content from the one or more audio sources. The method includes capturing a local audio stream from a communicator located in a same physical space as the player and determining a period of inactivity for a first audio source of the one or more audio sources. The method includes projecting the local audio stream from a first source location in the 3D audio space assigned to the first audio source during the period of inactivity.

### CROSS-REFERENCE TO RELATED APPLICATIONS

This application claims priority to U.S. Provisional Application No. 63/727,618, filed December 3, 2024, entitled “INSERTING EXTERNAL COMMUNICATIONS DURING INACTIVE PERIODS OF A CHANNEL IN 3D AUDIO SPACE PROVIDING DIRECTIONAL AUDIO,” the content of which is herein incorporated by reference in its entirety for all purposes.

### TECHNICAL FIELD

The present disclosure is related to providing directional audio in a three dimensional audio space for corresponding audio sources, and the insertion of external communications into channels of an audio source that is inactive. In that manner, local communication may be heard by a player while minimizing interference with gaming audio.

### BACKGROUND OF THE DISCLOSURE

Video games and/or gaming applications and their related industries (e.g., video gaming) are extremely popular and represent a large percentage of the worldwide entertainment market. Video games are played anywhere and at any time using various types of platforms, including gaming consoles, desktop computers, laptop computers, mobile phones, tablet computers, etc.

During game play of a video game, a user may be listening to multiple audio sources in addition to the audio generated for the game play. For example, the user may be participating in a chat audio source with other participants. The audio from the chat audio source is mixed with the gaming audio, such as placing the audio from the chat audio source indiscriminately over the audio from the game play. Further, the user may have more than one audio sources open during the game play, each of which is placed on top of the gaming audio. Certain audio may not be distinguishable because of audio conflicts.

It is in this context that embodiments of the disclosure arise.

### SUMMARY

Embodiments of the present disclosure relate to providing directional audio in a three dimensional (3D) audio space for each of one or more audio sources. The audio sources may provide additional audio to audio from an application, such as a video game. External communication that is detected may be presented within inactive periods of a corresponding audio source. In that manner, the external communication may be presented while minimizing conflict with audio from gaming audio and audio from the audio sources.

In one embodiment, a method is disclosed. The method including defining a three dimensional (3D) audio space configured to provide localized audio sound with directionality in the 3D audio space. The method including localizing gaming audio from a game play of a video game of a player within the 3D audio space. The method including receiving content from one or more audio sources. The method including assigning one or more source locations in the 3D audio space to the one or more audio sources, wherein each audio source is assigned to a corresponding source location. The method including projecting audio of the content from the one or more audio sources, wherein corresponding audio of corresponding content from each of the one or more audio sources is projected from a corresponding source location. The method including capturing local commentary from a communicator located in a physical space within which the player is playing the video game. The method including monitoring the content from the one or more audio sources. The method including determining a period of inactivity ending with a current time for a first audio source, wherein corresponding content from the first audio source is not received during the period of inactivity, The method including projecting the local commentary from a first source location in the 3D audio space assigned to the first audio source.

In still another embodiment, a computer system is disclosed, wherein the computer system includes a processor and memory coupled to the processor and having stored therein instructions that, if executed by the computer system, cause the computer system to execute a method. The method including defining a three dimensional (3D) audio space configured to provide localized audio sound with directionality in the 3D audio space. The method including localizing gaming audio from a game play of a video game of a player within the 3D audio space. The method including receiving content from one or more audio sources. The method including assigning one or more source locations in the 3D audio space to the one or more audio sources, wherein each audio source is assigned to a corresponding source location. The method including projecting audio of the content from the one or more audio sources, wherein corresponding audio of corresponding content from each of the one or more audio sources is projected from a corresponding source location. The method including capturing local commentary from a communicator located in a physical space within which the player is playing the video game. The method including monitoring the content from the one or more audio sources. The method including determining a period of inactivity ending with a current time for a first audio source, wherein corresponding content from the first audio source is not received during the period of inactivity, The method including projecting the local commentary from a first source location in the 3D audio space assigned to the first audio source.

In another embodiment, a non-transitory computer-readable medium storing a computer program for performing a method is disclosed. The non-transitory computer-readable medium including program instructions for defining a three dimensional (3D) audio space configured to provide localized audio sound with directionality in the 3D audio space. The non-transitory computer-readable medium including program instructions for localizing gaming audio from a game play of a video game of a player within the 3D audio space. The non-transitory computer-readable medium including program instructions for receiving content from one or more audio sources. The non-transitory computer-readable medium including program instructions for assigning one or more source locations in the 3D audio space to the one or more audio sources, wherein each audio source is assigned to a corresponding source location. The non-transitory computer-readable medium including program instructions for projecting audio of the content from the one or more audio sources, wherein corresponding audio of corresponding content from each of the one or more audio sources is projected from a corresponding source location. The non-transitory computer-readable medium including program instructions for capturing local commentary from a communicator located in a physical space within which the player is playing the video game. The non-transitory computer-readable medium including program instructions for monitoring the content from the one or more audio sources. The non-transitory computer-readable medium including program instructions for determining a period of inactivity ending with a current time for a first audio source, wherein corresponding content from the first audio source is not received during the period of inactivity, The non-transitory computer-readable medium including program instructions for projecting the local commentary from a first source location in the 3D audio space assigned to the first audio source.

Other aspects of the disclosure will become apparent from the following detailed description, taken in conjunction with the accompanying drawings, illustrating by way of example the principles of the disclosure.

### BRIEF DESCRIPTION OF THE DRAWINGS

The disclosure may best be understood by reference to the following description taken in conjunction with the accompanying drawings in which:

FIG. 1A illustrates a system configured for providing directional audio in a three dimensional (3D) audio space and the insertion of local communication in a period of inactivity for a corresponding audio source, in accordance with one embodiment of the present disclosure.

FIG. 1B illustrates a block diagram of an audio source three dimensional (3D) space localizer configured to provide directional audio in a 3D audio space and insertion of local communication in a period of inactivity for a corresponding audio source, in accordance with one embodiment of the present disclosure.

FIG. 2 is a flow diagram illustrating a method for inserting local communication for an audio source that is inactive in a 3D audio space providing directional audio, in accordance with one embodiment of the present disclosure.

FIG. 3 illustrates a 3D audio space within which one or more audio sources may be assigned to source locations within the audio space, in accordance with one embodiment of the present disclosure.

FIG. 4 illustrates components of an example device that can be used to perform aspects of the various embodiments of the present disclosure.

### DETAILED DESCRIPTION

Although the following detailed description contains many specific details for the purposes of illustration, anyone of ordinary skill in the art will appreciate that many variations and alterations to the following details are within the scope of the present disclosure.

Accordingly, the aspects of the present disclosure are set forth without any loss of generality to, and without imposing limitations upon, the claims that follow this description.

Generally speaking, the various embodiments of the present disclosure describe systems and methods for providing directional audio in a three dimensional (3D) audio space for corresponding audio sources, and insertion of local communication in place of audio from one of the audio sources that is inactive. The 3D audio space may be defined and/or implemented by any 3D audio system, such as systems providing surround sound capabilities, 3D headsets, sound bars, headphones, etc. The audio sources provide distinct audio content received over different input streams, such as chat, local communication, converted text from a text source, friend audio sources, audio sources of followers, game sound effects, music, music from a streaming service, etc. The audio from different audio sources can be mixed with audio from an underlying application (e.g., video game). For example, a chat audio source of users on a team, and another audio source providing communications from friends may be mixed with the audio from the video game. Spatial separation of audio sources helps a user to distinguish audio from those audio sources (e.g., multi-channel representations, etc.), and/or audio from the video game. In addition, local communication coming from a physical space within which a player is playing a video game may be introduced into the audio heard by the player. Local communication can be inserted for one of the audio sources, wherein the local communication is broadcast instead of the audio from an audio source that is inactive. In some implementations, artificial intelligence (AI) is configured to monitor audio from audio sources in order to detect inactive periods, and to insert local communication in place of audio from an audio source that is inactive.

Advantages of the methods and systems, configured for inserting local communication in place of audio from an audio source that is inactive in a 3D audio space that provides directional audio for corresponding audio sources and an underlying application (e.g., video game), include capture and projection of local communication that a player may not normally hear over the gaming audio and audio from the other established audio sources. For example, the local communication may not be loud enough, or the player is concentrating on the gaming audio and audio from the audio sources, and tunes out the local communication. Further, the local communication is broadcasted and/or projected during a detected inactive period of an audio source, and furthermore broadcasted from the same source location of that audio source. In that manner, the local communication may be isolated from audio of the various audio sources, and projected and/or broadcast without interference from the other audio sources. As such, local communication that is external to playing of a video game may be heard by the player.

Throughout the specification, the reference to “game” or video game” or “gaming application” or “application” is meant to represent any type of interactive application that is directed through execution of input commands. For illustration purposes only, an interactive application includes applications for gaming, word processing, video processing, video game processing, etc. Also, the terms “virtual world” or “virtual environment” or “metaverse” is meant to represent any type of environment generated by a corresponding application or applications for interaction between a plurality of users in a multi-player session or multi-player gaming session. Furthermore, the term “platform” refers to a combination of hardware and software components providing a set of capabilities in order to execute one or more software applications (e.g., video games). For example, the term “platform” may be used with reference to “devices of a particular platform” or “cross-platform devices.” Moreover, suitable terms introduced above are interchangeable.

With the above general understanding of the various embodiments, example details of the embodiments will now be described with reference to the various drawings.

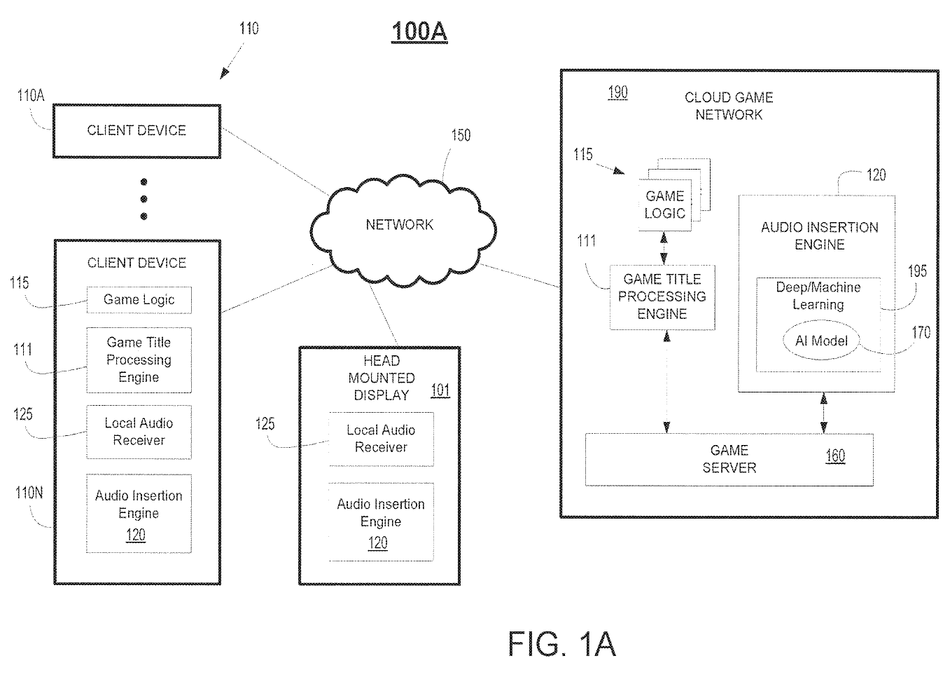

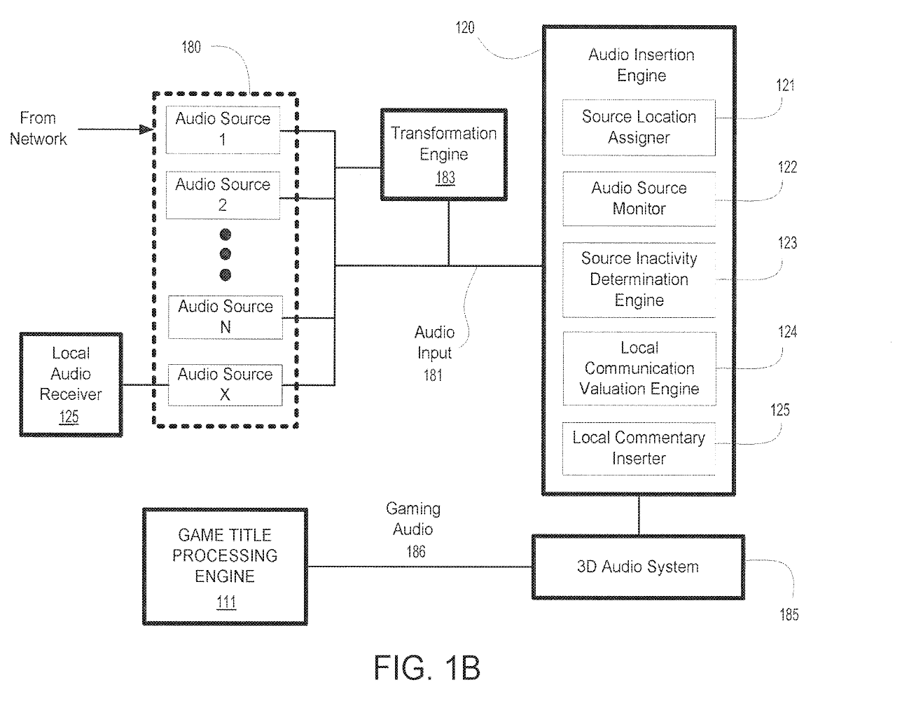

FIG. 1A illustrates a system configured for providing directional audio in a three dimensional audio space for corresponding audio sources and insertion of local communication in place of audio from one of the audio sources that is inactive, in accordance with one embodiment of the present disclosure. In that manner, communication external from audio associated with playing of a video game may be isolated and broadcast during an inactive period of audio from a corresponding audio source.

Throughout the specification, the reference to “an audio source” is meant to include different types//categories/sources of audio, that may be independent of the actual audio format. For example, an audio source may include mono-channel and/or multi-channel representations (e.g., two channels for stereo, eight channels for a 7.1 audio system, thirty-six channels for an Ambisonics system, one-hundred twenty-eight channels for an object-based audio system, etc.). As an illustration, one audio source may include gaming audio including a multi-channel signal from a video game, and another audio source may include voice content (e.g., chat, etc.).

As shown, system 100 may provide gaming over a network 150 for one or more client devices 110 (e.g., 110A through 110N) of one or more users. In particular, system 100 may be configured to enable users to interact with interaction applications, including provide gaming to users participating in a single-player or multi-player gaming sessions (e.g., participating in a video game in single-player or multi-player mode, or participating in a metaverse generated by an application with other users, etc.) via a cloud game network 190, wherein the game can be executed locally (e.g., on a local client device 110 of a corresponding user) or can be executed remotely from a corresponding client device 110 (e.g., acting as a thin client) of the corresponding user that is playing the video game, in accordance with one embodiment of the present disclosure. In at least one capacity, the cloud game network 190 supports a multi-player gaming session for a group of users, to include delivering and receiving game data of players for purposes of coordinating and/or aligning objects and actions of players within a scene of a gaming world or metaverse, managing communications between user, etc., so that the users in distributed locations participating in a multi-player gaming session can interact with each other in the gaming world or metaverse in real-time. In another capacity, the cloud game network 190 supports multiple users participating in a metaverse.

In some embodiments, the cloud game network 190 may include a plurality of virtual machines (VMs) running on a hypervisor of a host machine, with one or more virtual machines configured to execute a game processor module utilizing the hardware resources available to the hypervisor of the host. It should be noted, that access services, such as providing access to games of the current embodiments, delivered over a wide geographical area often use cloud computing. Cloud computing is a style of computing in which dynamically scalable and often virtualized resources are provided as a service over the internet.

In a multi-player session allowing participation for a group of users to interact within a gaming world or metaverse generated by an application (which may be a video game), some users may be executing an instance of the application locally on a client device (e.g., gaming console, tablet, mobile phone, etc.) to participate in the multi-player session. Other users who do not have the application installed on a selected device or when the selected device is not computationally powerful enough to executing the application may be participating in the multi-player session via a cloud based instance of the application executing at the cloud game network 190.

As shown, the cloud game network 190 includes a game server 160 that provides access to a plurality of video games. Applications played in a corresponding single player and/or multi-player session may be played over the network 150 with connection to the game server 160. For example, in a multi-player session involving multiple instances of an application (e.g., generating virtual environment, gaming world, metaverse, etc.), a dedicated server application (session manager) collects data from users and distributes it to other users so that all instances are updated as to objects, characters, etc. to allow for real-time interaction within the virtual environment of the multi-player session, wherein the users may be executing local instances or cloud based instances of the corresponding application. In particular, game server 160 may manage a virtual machine supporting a game processor that instantiates a cloud based instance of an application for a user. As such, a plurality of game processors of game server 160 associated with a plurality of virtual machines is configured to execute multiple instances of one or more applications associated with gameplays of a plurality of users. In that manner, back-end server support provides streaming of media (e.g., video, audio, etc.) of gameplays of a plurality of applications (e.g., video games, gaming applications, etc.) to a plurality of corresponding users. That is, game server 160 is configured to stream data (e.g., rendered images and/or frames of a corresponding gameplay) back to a corresponding client device 110 through network 150. As such, a computationally complex gaming application may be executing at the back-end server in response to controller inputs received and forwarded by client device 110. Each server is able to render images and/or frames that are then encoded (e.g., compressed) and streamed to the corresponding client device for display.

In single-player or multi-player sessions, instances of an application may be executing locally on a client device 110, head mounted display (HMD) 101, or at the cloud game network 190, or a combination therein. In any case, the application as game logic 115 is executed by a game engine 111 (e.g., game title processing engine). For purposes of clarity and brevity, the implementation of game logic 115 and game engine 111 is described within the context of the cloud game network 190. In particular, the application may be executed by a distributed game title processing engine (referenced herein as “game engine”). In particular, game server 160 and/or the game title processing engine 111 includes basic processor based functions for executing the application and services associated with the application. For example, processor based functions include 2D or 3D rendering, physics, physics simulation, scripting, audio, animation, graphics processing, lighting, shading, rasterization, ray tracing, shadowing, culling, transformation, artificial intelligence, etc. In that manner, the game engines implement game logic, perform game calculations, physics, geometry transformations, rendering, lighting, shading, audio, as well as additional in-game or game-related services. In addition, services for the application include memory management, multi-thread management, quality of service (QoS), bandwidth testing, social networking, management of social friends, communication with social networks of friends, social utilities, communication audio sources, audio communication, texting, messaging, instant messaging, chat support, game play replay functions, help functions, etc.

In one embodiment, the cloud game network 190 may support artificial intelligence (AI) based services including chatbot services (e.g., ChatGPT, etc.) that provide for one or more features, such as conversational communications, composition of written materiel, composition of music, answering questions, simulating a chat room, playing games, and others.

Users access the remote services with client devices 110, which include at least a CPU, a display and input/output (I/O). For example, users may access cloud game network 190 via communications network 150 using corresponding client devices 110 configured for providing input control, updating a session controller (e.g., delivering and/or receiving user game state data), receiving streaming media, etc. The client device 110 can be a personal computer (PC), a mobile phone, a personal digital assistant (PAD), handheld device, etc.

The client devices 110 may be operating using different platforms. For example, one or more client devices may be operating on a first platform (e.g., gaming consoles), and other client devices may be operating a different platform (mobile phones). In still another platform, a platform includes both a client device and game server 160 located at the cloud game network 190 in support of a cloud based instance of an application. As previously described, each platform may include a combination of hardware and software components providing a set of capabilities in order to execute one or more software applications (e.g., video games).

In particular, client device 110 of a corresponding user is configured for requesting access to applications over a communications network 150, such as the internet, and for rendering for display images generated by a video game executed by the game server 160, wherein encoded images are delivered (i.e., streamed) to the client device 110 for display. For example, the user may be interacting through client device 110 with an instance of an application executing on a game processor of game server 160 using input commands to drive a gameplay. Client device 110 may receive input from various types of input devices, such as game controllers, tablet computers, keyboards, touch screens, gestures captured by video cameras, mice, touch pads, audio input, etc.

As previously introduced, client device 110 may be configured with a game title processing engine 111 and game logic 115 (e.g., executable code) that is locally stored for at least some local processing of an application, and may be further utilized for receiving streaming content as generated by the application executing at a server, or for other content provided by back-end server support. In another implementation, client decide 110 acts as a stand-alone system for purposes of executing the application, such as when supporting a game play of a video game.

Client device 110 may include a local audio receiver 125, or receive audio from a local receiver, configured for receiving local audio communications. For example, a user may be located within a room, and receiver 125 may pick up local audio, such as communications from another local person (e.g., within the room or from an adjoining room, external noises generated from the local environment, etc.). The local audio receiver 125 may deliver captured audio to a 3D audio system that is providing 3D audio for the user.

In addition, client device 110 may include an audio insertion engine 120 configured for detecting an audio source that is inactive, and inserting the audio from the local communication in place of the audio from the audio source that is inactive. Furthermore, the local communication may be broadcast from a location in 3D audio space corresponding with the inactive audio source. In particular, an audio localizer (not shown) in the audio insertion engine provides directional audio from corresponding audio sources in combination with audio presented from an underlying application (e.g., video game) in 3D audio space. As such, audio from audio sources are spatially separated from each other and/or the gaming audio. That is, audio from multiple audio sources (e.g., chat, social media, game sound effects, streaming music, etc.) that originate from multiple applications (e.g., executing on a system) are spatially separated in the 3D audio space.

In another embodiment, client device 110 may be configured as a thin client providing interfacing with a back end server (e.g., game server 160 of cloud game network 190) configured for providing computational functionality (e.g., including game title processing engine 111 executing game logic 115 – i.e., executable code – implementing a corresponding application).

Services provided with client devices 110 may also be provided through HMD 101 or headset. In some implementations, the HMD includes at least a CPU, a display and input/output (I/O), and may operate independent of or in conjunction with a client device and/or cloud game network 190. HMD 101 is configured to provide user interaction with a virtual space/environment that is responsive in real-time to the movements of the HMD (as controlled by the user) to provide the sensation to the user of being in the virtual space or metaverse. HMD may be configured with a local audio receiver 125, or receive audio from a local receiver, as described previously. That is, the receiver in the HMD, or local to the HMD, is configured to capture local communication from a communicator located in a physical space within which the 3D audio space is defined, or adjacent to the defined 3D audio space.

In addition, HMD 101 may include an audio insertion engine 120, previously described, in one embodiment. In some implementations, the audio insertion engine 120 may be located at a client device 110 and/or a head mounted display 101, or a combination. That is, the audio insertion engine 120 may be local to a user, such as operating within a client device 110 and/or HMD 101 of the user, or may be remote from the user and operate at a back-end server. For example, the audio insertion engine 120 may be implemented at the back-end cloud game network. That is, the audio insertion engine 120 may be operating in isolation in the client device 110.

In particular, in some implementations artificial intelligence may be configured to identify and/or classify different audio sources (e.g., the source of the communication audio sources), audio from an underlying application, learn to assign different source locations for the audio sources within a 3D audio space to achieve spatial separation, learn user preferences for the assignment of source locations to different audio sources; detect periods of inactivity for an audio source, and insert local communication in place of the audio from the inactive audio source, as well as perform other functions and/or operations described herein, in order to reduce conflict between the local communication and audio from the audio sources and/or the gaming audio.

The classification and/or identification of audio sources, and the performing of additional operations, including detecting periods of inactivity for an audio source and inserting local communication in place of audio from an audio source that is inactive may be performed using artificial intelligence (AI) via an AI layer. For example, the AI layer may be implemented via an AI model 170 as executed by a deep/machine learning engine 195 of the recap engine 120. It is understood that one or more AI models may be implemented, each of which being configured to perform customized classification and/or identification and/or generation of data and/or services used to provide directional audio to different audio sources.

Purely for illustration, the deep/machine learning engine 195 may be configured as a neural network used to train and/or implement the AI model 170, in accordance with one embodiment of the disclosure. Generally, the neural network represents a network of interconnected nodes responding to input (e.g., extracted features) and generating an output related to projection of audio of audio sources and/or communications within an audio source at corresponding source locations. In particular, the AI model 170 is configured to apply rules defining relationships between features and outputs (e.g., assigning source locations, defining user preferences, assigning hierarchy of priorities between audio sources and/or communications within an audio source, assigning source locations and/or volume levels based on the hierarchies, detecting inactive periods for a corresponding audio source, valuing local communications, inserting local communications in place of audio from an inactive audio source, etc.), wherein features may be defined within one or more nodes that are located at one or more hierarchical levels of the AI model 170. The rules link features (as defined by the nodes) between the layers of the hierarchy, such that a given input set of data leads to a particular output (e.g., a key event during game play of a video game) of the AI model 170. For example, a rule may link (e.g., using relationship parameters including weights) one or more features or nodes throughout the AI model 170 (e.g., in the hierarchical levels) between an input and an output, such that one or more features make a rule that is learned through training of the AI model 170. That is, each feature may be linked with one or more features at other layers, wherein one or more relationship parameters (e.g., weights) define interconnections between features at other layers of the AI model 170. As such, each rule or set of rules corresponds to a classified output

FIG. 1B illustrates a block diagram of an audio insertion engine 120 configured to provide directional audio in a 3D audio space for corresponding audio sources and for inserting audio from local communication in place of the audio from the audio source that is inactive, in accordance with one embodiment of the present disclosure. The directional audio for corresponding audio sources may be provided in combination with audio 186 from an underlying application, such as gaming audio generated for a game play of a video game executing on game title processing engine 111. In particular, 3D audio system 185 provides 3D audio within a 3D audio space, and includes audio from the plurality of audio sources 180 and audio 186 (e.g., gaming audio). In that manner, the audio from the audio sources are spatially separated from each other and/or the audio 186 from the application. The audio insertion engine was previously introduced in FIG. 1A.

The 3D audio space may be defined and/or implemented by any 3D audio system, such as systems providing surround sound capabilities, 3D headsets, sound bars, headphones, stereo headphones, etc. For example, the surround sound capabilities may be implemented not only by setups with multiple loudspeakers (e.g., 7.1 audio systems, etc.), but can be provided by headsets and/or headphones that recreate a virtualized 3D audio space.

As shown, the audio insertion engine 120 receives audio input 181. The audio input 181 includes a plurality of audio sources 180 from one or more originating entities. Each of the audio sources correspond with different message types, such as chat services, texting services, social network communication, communication from friends, communication from followers, information provided related to the video game, communication from the local environment, etc. In some cases, the audio sources (e.g., audio sources 1-N0 are received over a network (e.g., social communications, telecom communications, etc.).

In addition, audio is captured from a local audio receiver 125 and grouped under one audio source (e.g., audio source X). For example, the receiver 125 captures local communication from persons located in the same physical environment as the player (e.g., in the same or adjoining room as a player playing a video game). In some cases, the local communication is from a distance or orientation that makes the volume very low. In that case, additional modification to the local communication may be performed, including increasing the volume of the local communication and/or increasing resolution of the audio, etc.

Transformation engine 183 is configured to convert communication from one or more audio sources into an audio format suitable for broadcast via the 3D audio system 185. For example, one audio source may provide textual communications that are translated by transformation engine 183 into audio communications.

The audio insertion engine 120 includes a source location assigner 121 that is configured to define a corresponding source location for each of the plurality of audio sources 180 provided as input within a 3D audio space. The source location assigner 121 assigns source locations based on user input (e.g., via UI), predefined user preferences, predefined rules, learned rules using AI, or a combination thereof.

In particular, audio from multiple audio sources (e.g., chat, social media, game sound effects, streaming music, etc.) may originate from multiple applications (e.g., executing on a system). That is, the spatialized audio may be generated by or coming from multiple independent programs and/or applications simultaneously executing on a system. For example, a streaming music player (application) could be assigned to one spatial location in the 3D audio space, while chat communication from a social media application may be assigned to another spatial location. As such, directional audio from each audio source is presented to the player within the 3D audio space, such that audio of a corresponding audio source originates from a corresponding source location in the 3D audio space. Directional audio is provided in a three dimensional audio space for corresponding audio sources in combination with 3D audio presented from an underlying application, such as gaming audio. Spatial separation of audio sources, and/or communications within an audio source, within the 3D audio space is dynamically maintained to reduce conflicts between the audio broadcast from corresponding source locations.

The audio source 3D space localizer 120 includes an audio source monitor 124 configured for monitoring audio from each of the audio sources. In particular, activity is monitored for each audio source. In that manner, the source inactivity determination engine 123 is able to determine which audio sources are currently active and which are inactive. For example, the inactivity determination engine 123 is able to track a period of inactivity for a corresponding audio source, and determine whether the period of inactivity exceeds a threshold period of time.

In addition, the source inactivity determination engine 123 may be configured to prioritize communication between the audio sources. Priority may be used to determine which audio source and its corresponding communication will be replaced with the local communication. For example, communication from an audio source with lower priority is a better candidate for insertion of local communication and/or commentary over an audio source with higher priority. In another example, communication from an audio source that simulates a direction from which a communicator is speaking to the player playing the video game is a good candidate for insertion of local communication and/or commentary.

In addition, a local communication valuation engine 124 is configured to analyze the local communication and assign an importance valuation to each communication, based on the content of the local communication. For example, local communication of high importance is projected within the 3D audio space, such as being inserted in place of audio from an inactive audio source. Important communication may include emergency information (e.g., fire), or communication from an important person (e.g., mother of player), or communication from a friend that is spectating the game play of the player in the same room, etc. On the other hand, local communication of low importance may be filtered, such that communication of low importance is not projected within the 3D audio space. An example of communication with low importance may include background communication that is not directed to the player.

As such, the local commentary inserter 125 is configured to insert local communication and/or commentary that is captured in place of audio from an audio source that is determined to be inactive for a period of time. Further, the local communication may be filtered, such that communication of high importance is projected into the 3D audio space, whereas communication of low importance is filtered and not projected. In that manner, local communication is projected in a manner that is not in audio conflict with at least one audio source (i.e. the inactive audio source).

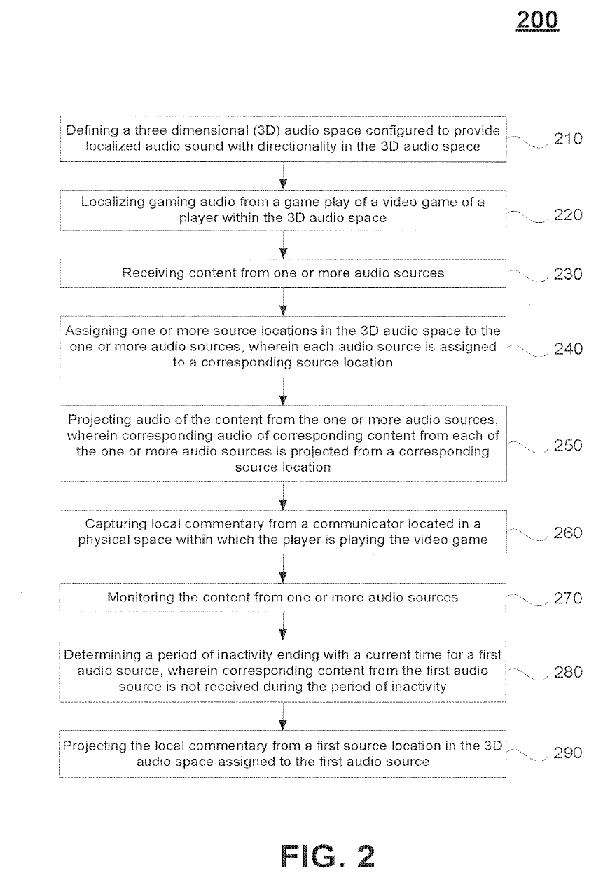

With the detailed description of the system 100 of FIG. 1A and the audio insertion engine 120 of FIG. 1B, flow diagram 200 of FIG. 2 discloses a method for inserting local communication for an audio source that is inactive in a 3D audio space providing directional audio, in accordance with one embodiment of the present disclosure. In that manner, communication external to audio associated with playing a video game may be broadcast to the player in a manner that reduces conflicts with other audio sources. The operations performed in the flow diagram may be implemented by one or more of the previously described components of system 100 described in FIGS. 1A-1B, including the audio insertion engine 120.

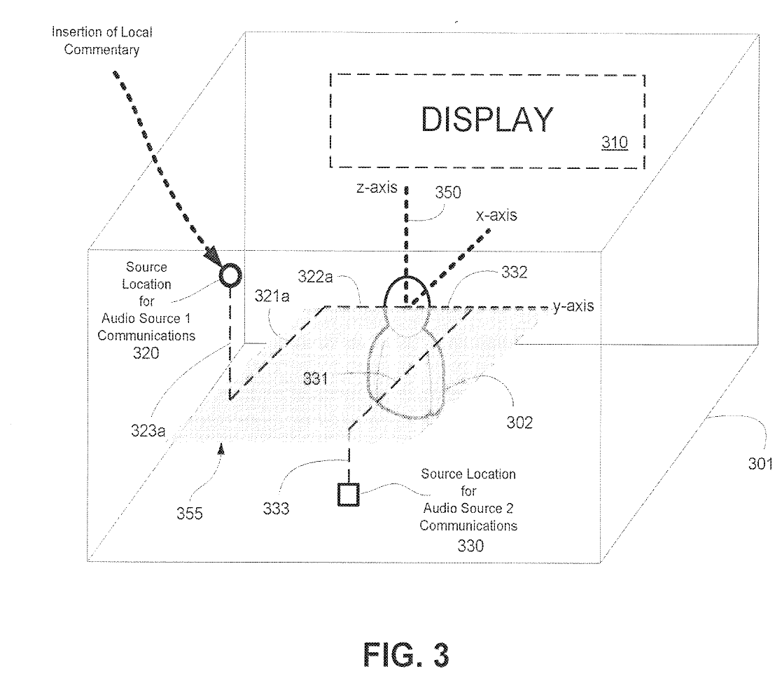

At 210, the method includes defining a 3D audio space for use by an audio system configured to provide localized sound with directionality in the 3D audio space. 3D audio, or surround sound, is configured to give directionality to audio or sounds presented to a listener or user of the system. In one implementation, the 3D audio is generated with a 3D audio system (e.g., system 185) that includes multiple speakers, and a possibly a subwoofer. In another implementation, a 3D audio space may be defined by an HMD configured to present 3D audio to a user. Generally, the 3D audio system generates or modifies audio input (e.g., audio sources, gaming audio, etc.) using different techniques (e.g., software implemented) based on a defined 3D audio space, so that corresponding audio originates from corresponding locations within the 3D audio space. An example of the 3D audio space as defined and implemented by a 3D audio system is provided in FIG. 3.

At 220, the method includes localizing gaming audio from an underlying application, such as a game play of a video game within the 3D audio space using the 3D audio system. For example, gaming audio is generated for 3D audio capability. That is, the audio signals generated by the video game are formatted for presentation within the 3D audio space. A 3D audio system receiving the audio signals from the video game is configured to further manipulate the audio appropriately to present 3D audio within the defined 3D audio space.

At 230, the method includes receiving content from one or more audio sources. Each of the audio sources correspond with different message types (e.g., chat, friend communication, social media, game sound effects, streaming music, etc.) that originate from multiple applications (e.g., executing on a system). For example, the spatialized audio may be generated by or coming from multiple independent programs and/or applications simultaneously executing on a system.

At 240, the method includes assigning one or more source locations in the 3D audio space to the one or more audio sources, wherein each audio source is assigned to a corresponding source location. In that manner, audio of a corresponding audio source originates from the defined source location in 3D audio space as presented using the 3D audio system. The source location also may correspond to a location in physical space, from which the corresponding audio seemingly originates. Further, the source location may be tied to a virtual reality (VR) space when using an HMD.

At 250, the method includes projecting audio of the content from the one or more audio sources using the audio system. In particular, the 3D audio system is configured to manipulate audio input such that audio from an audio source originates and/or seemingly originates from the defined source location within the 3D audio space. In particular, corresponding audio of corresponding content from each of the one or more audio sources is projected from a corresponding source location. When source locations are assigned to reduce conflicts between audio sources, the audio from one audio source is distinguishable from audio from another audio source.

At 260, the method includes capturing local communication and/or commentary from a communicator located in a physical space within which the player is playing the video game. For example, the local communication may be from someone in the same room that is trying to communicate with the player, such as when telling the player that it is time for dinner, or when trying to converse with the player. In another case, the local communication may be urgent, such as when the communicator is trying to tell the player that there is an emergency, and that everyone is evacuating the house.

At 270, the method includes monitoring the content from the one or more audio sources. In particular, each audio source is monitored to establish when communication is being received from the audio source. In that manner, patterns of communication may be determined, such as when the communication from the audio source is busy, or when the communication is moderate, or when the communication is very slow, or inactive.

At 280, the method includes determining a period of inactivity ending with a current time for a first audio source. During the period of inactivity, corresponding content from the first audio source is not received. As such, up to the current time there has been no communication received from the first audio source over the period of inactivity. In one embodiment, the period of inactivity exceeds a threshold. When the period of inactivity exceeds the threshold, this may indicate that the audio source is inactive, or at least idle, and that there most likely will not be any additional communication from the first audio source.

At 290, the method includes projecting the local commentary from a first source location in the 3D audio space assigned to the first audio source. In particular, after determining that the first audio source has been inactive for at least a period of inactivity, the local communication and/or commentary is inserted into that period of inactivity. In other words, when external communications are detected, that communication may be presented within inactive areas of the 3D audio space, corresponding with an audio source, that are detected. In that manner, the local commentary may be broadcast in place of audio from the first audio source, wherein the external and local communication would be presented from a source location corresponding to the inactive audio source. In one embodiment, if audio is subsequently received from the first audio source, that audio is buffered and not projected until after the local commentary has completed broadcasting, or for a period of time reserved for broadcasting the local commentary.

Because the local commentary is projected and/or broadcasted from the first source location assigned to the first audio source, the audio from multiple audio sources has been spatially separated in the 3D audio space. As such, the local commentary is also spatially separated from the audio coming from the other audio sources. In that manner, the local commentary is distinguishable from audio from the other audio sources.

Also, because the local commentary is projected in place of the audio from the first audio source, the audio conflict is at least minimized between the local commentary and the audio from the first audio source. In some implementations, the local commentary is broadcast during a period in which all or most of the audio sources are determined to be inactive. In that manner, the local commentary is ensured to have minimal audio conflict with audio from other audio sources, but may conflict with gaming audio.

In one embodiment, the method determines that the period of inactivity for the first audio source does not exceed a threshold. However, the first audio source is still selected for insertion procedures. For example, it may be determined that the local communication has high importance, and should be broadcast. In comparison, local communication of low importance may not be broadcast to the player by the audio system. When the local commentary is to be projected, one or more audio sources may be detected and assigned to a priority hierarchy. The hierarchy may be influenced by user preference, pre-defined rules, AI rules, AI learned rules of user preferences. An audio source (e.g., the first audio source) with the lowest priority may be selected for insertion procedures, such that the audio from the first audio source with the lowest priority is not broadcast from its corresponding source location, and instead the local commentary is projected from the corresponding source location. In some implementations, the audio from the first audio source is paused, especially when communication from the first audio source is still being received, while the local commentary is being projected from the corresponding source location that is assigned to the first audio source.

In another embodiment, the local communication and/or commentary is projected from an approximate location of the communicator. In particular, a direction from the communicator to the player in the physical space occupied by both is determined, wherein this direction may indicate from where the location is being broadcast in relation to the player. As such, the direction can be used to place the first source location in the 3D audio space in alignment with the direction from which the local commentary of the communicator is projected in physical space. In that manner, the local commentary may be projected from a source location as if the player is actually hearing the commentary from the communicator in physical space (i.e., from the direction). In one embodiment, an audio source that is projecting from a source location that is closest to the first source location (e.g., in alignment with the direction) is selected, such that the local communication and/or commentary is projected from the source location of the selected audio source, wherein the local commentary is projected from that source location in place of the audio of the selected audio source.

In one embodiment, a notification is provided that informs the player that there is local communication and/or commentary that will soon be projected. In that manner, the player is made aware that communication external from playing the game is incoming, such that the player is able to mentally isolate the incoming external communication from gaming audio and also audio from other audio sources.

FIG. 3 illustrates a 3D audio space within which one or more audio sources may be assigned to source locations within the audio space, in accordance with one embodiment of the present disclosure. For purposes of illustration, the 3D audio space is represented by a rectangular box, but may be represented using any other representation. The 3D audio space may be implemented by a 3D audio system, such as a home entertainment system, or head mounted display, etc. A user 302 is also shown placed within the 3D audio space, so that the user is able to experience 3D audio in full.

In some implementations, the 3D audio space may be defined within a physical environment. In other implementations, the 3D audio space is defined around the user 302. In still other implementations, the 3D audio space is defined with respect to a HMD. Display 310 may be a display located in a room, or a display implemented within an HMD. In particular, 3D audio, or surround sound, is configured to give directionality to audio or sounds presented to a listener or user of the system. In one implementation, the 3D audio is generated with a 3D audio system, including a controller (e.g., receiver) and one or more speakers (e.g., soundbar, speakers, subwoofer, etc.). For example, the 3D audio system may include speakers that are located in various locations throughout the physical space (e.g., room). Some example configurations of speakers are provided by a 5.1 3D audio system (including 5 speakers and 1 subwoofer) and a 7.1 3D audio system (including 7 speakers and 1 subwoofer). Directionality is achieved through distribution of sound components to selected speakers and software manipulation of the sound components depending on the number of speakers and configuration of those speakers within the physical space. In another implementation, a 3D audio space may be defined by an HMD configured to present 3D audio to a user. Generally, the 3D audio system 304 generates or modifies audio input (e.g., audio sources, gaming audio, etc.) based on a defined 3D audio space, so that corresponding audio (e.g., from audio sources or gaming system, etc.) originates from corresponding locations within the 3D audio space.

In particular, the 3D audio system generates or modifies audio input (e.g., audio sources, gaming audio, etc.) based on the defined 3D audio space 301. The 3D audio space may be defined based on knowledge of the physical space through which the audio is presented. For example, various models may be utilized representing the 3D audio space, such as a box model, or spherical model. For purposes of illustration, the 3D audio space 301 is shown in FIG. 3 as a rectangular space (e.g., corresponding with a room), which may be expandable, though it can also be represented by a sphere, or any other shape. The center of the 3D audio space anchors the 3D coordinate system 350, including an x-axis, a y-axis, and a z-axis. As shown, the x-axis extends out in a positive direction from the front of the user. The 3D coordinate system 350 may be used to provide positioning information of audio originating within the visual/virtual representation 301 of the 3D audio space 301. For clarity in positioning within the 3D coordinate system 350 a portion of a horizontal plane 355, defined by the x-axis and the y-axis, is shown in gray, and with transparency. For example, the head of the user is centered about the origin of the 3D coordinate system 350.

Furthermore, different techniques may be implemented to provide directionality. For example, audio components may be mixed at a content level for a particular set of audio sources in a particular configuration through a physical space. In another example, audio sources are located within a spherical 3D space (such as that shown in FIG. 3), and audio components are generated according to those locations via software manipulation. Other techniques are also utilized for generating 3D audio. In that manner, an audio component appears to the user to originate from a specific location within the 3D audio space.

As previously described, a plurality of audio sources of a plurality of message types may be positioned throughout the representation 301 of the 3D audio space 301. In particular, a plurality of audio sources is located at corresponding locations, each of which is indicated by a corresponding shape (e.g., circle, box, etc.). For example, a circular icon represents audio source 1 (one), and a box icon represents audio source 2 (two).

More particularly, source location 320 for audio source 1 (i.e., circle icon) is shown above the horizontal plane 355, and behind the user who is positioned at the center of the representation 301A of the 3D audio space 301. For instance, source location 320 may be further defined by an x-component 321a, a y-component 322a, and a z component 323a. As such, source location 320 for audio source 1 is located above and behind the user 302. That is, communications from audio source 1 is projected to originate from source location 320 by the corresponding 3D audio system.

Also, a source location 330 for audio source 2 (i.e., box icon) is shown below the horizontal plane 355, and also behind the user positioned at the center of the visual/virtual representation 301A of the 3D audio space 301. For instance, source location 330 may be further defined by an x-component 331, a y-component 332, and a z component 333. As such, source location 330 for audio source 2 is located below and behind the user 302. That is, communications from audio source 2 is projected to originate from source location 330 by the corresponding 3D audio system.

In embodiments of the present disclosure, local communication and/or commentary may be inserted in place of audio from an audio source that is detected to be inactive. For example, audio from audio source 1 (i.e., circle icon) may be detected to be in an inactive period. In that case, the local communication may be projected in place of the audio from audio source 1. In particular, the local commentary may be projected from the source location 320 for audio source 1, that is located above and behind the user 302, using the corresponding 3D audio system.

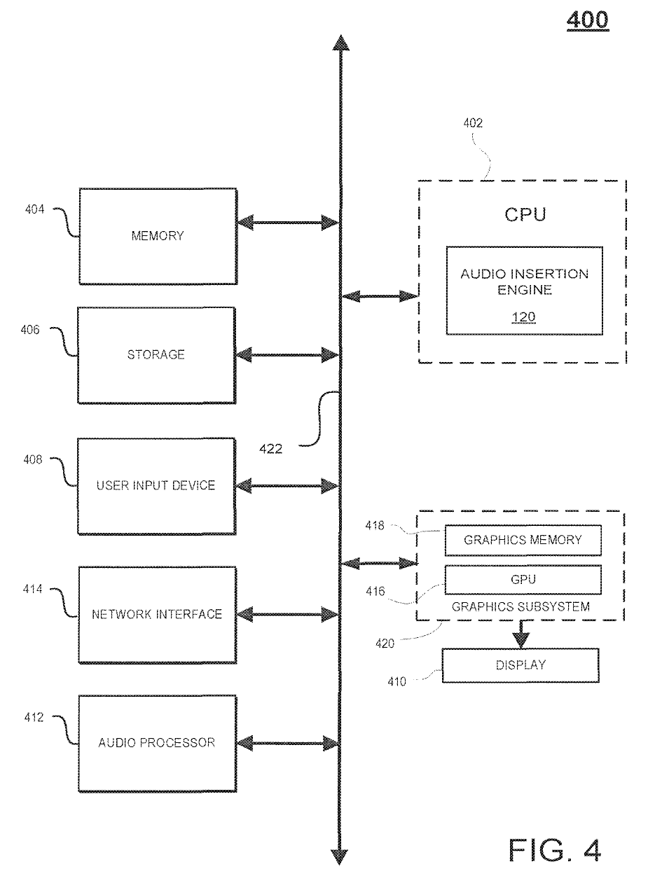

FIG. 4 illustrates components of an example device 400 that can be used to perform aspects of the various embodiments of the present disclosure. This block diagram illustrates a device 400 that can incorporate or can be a personal computer, video game console, personal digital assistant, a server or other digital device, and includes a central processing unit (CPU) 402 for running software applications and optionally an operating system. CPU 402 may be comprised of one or more homogeneous or heterogeneous processing cores. Further embodiments can be implemented using one or more CPUs with microprocessor architectures specifically adapted for highly parallel and computationally intensive applications.

In particular, CPU 402 may be configured to implement an audio insertion engine 120 that is configured to provide insertion of local communication and/or commentary in place of audio from an audio source that is inactive, wherein the local commentary is projected from a source location in 3D audio space assigned to the inactive audio source. In particular, a 3D audio system provides directional audio in a three dimensional audio space for corresponding audio sources, in combination with 3D audio presented from an underlying application, such as a game play of a video game. In that manner, directional audio from each audio source, or from each of the communications within an audio source, is presented to the user within the 3D audio space, such that audio of a corresponding audio source, and/or communication within an audio source, originates from a corresponding source location in the 3D audio space. As such, the audio from the audio sources, and/or communications within an audio source, are spatially separated from each other and/or the audio from the application. Each of the audio sources correspond with different message types, such as chat services, texting services, communication from friends, communication from followers, information provided related to the video game, communication from the local environment, etc. Because the audio from the audio sources are spatially separated, the local commentary inserted in place of audio from an inactive audio source will also be spatially separated from audio of other audio sources, and also separated from audio from at least the audio source that is inactive.

Memory 404 stores applications and data for use by the CPU 402. Storage 406 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 408 communicate user inputs from one or more users to device 400, examples of which may include keyboards, mice, joysticks, touch pads, touch screens, still or video recorders/cameras, tracking devices for recognizing gestures, and/or microphones. Network interface 414 allows device 400 to communicate with other computer systems via an electronic communications network, and may include wired or wireless communication over local area networks and wide area networks such as the internet. An audio processor 412 is adapted to generate analog or digital audio output from instructions and/or data provided by the CPU 402, memory 404, and/or storage 406. The components of device 400 are connected via one or more data buses 422.

A graphics subsystem 420 is further connected with data bus 422 and the components of the device 400. The graphics subsystem 420 includes a graphics processing unit (GPU) 416 and graphics memory 418. Graphics memory 418 includes a display memory (e.g., a frame buffer) used for storing pixel data for each pixel of an output image. Pixel data can be provided to graphics memory 418 directly from the CPU 402. Alternatively, CPU 402 provides the GPU 416 with data and/or instructions defining the desired output images, from which the GPU 416 generates the pixel data of one or more output images. The data and/or instructions defining the desired output images can be stored in memory 404 and/or graphics memory 418. In an embodiment, the GPU 416 includes 3D rendering capabilities for generating pixel data for output images from instructions and data defining the geometry, lighting, shading, texturing, motion, and/or camera parameters for a scene. The GPU 416 can further include one or more programmable execution units capable of executing shader programs. In one embodiment, GPU 416 may be implemented within an AI engine (e.g., machine learning engine 195) to provide additional processing power, such as for the AI, machine learning functionality, or deep learning functionality, etc.

The graphics subsystem 420 periodically outputs pixel data for an image from graphics memory 418 to be displayed on display device 410. Display device 410 can be any device capable of displaying visual information in response to a signal from the device 400.

In other embodiments, the graphics subsystem 420 includes multiple GPU devices, which are combined to perform graphics processing for a single application that is executing on a CPU. For example, the multiple GPUs can perform alternate forms of frame rendering, including different GPUs rendering different frames and at different times, different GPUs performing different shader operations, having a master GPU perform main rendering and compositing of outputs from slave GPUs performing selected shader functions (e.g., smoke, river, etc.), different GPUs rendering different objects or parts of scene, etc. In the above embodiments and implementations, these operations could be performed in the same frame period (simultaneously in parallel), or in different frame periods (sequentially in parallel).

Accordingly, in various embodiments the present disclosure describes systems and methods configured for providing directional audio in a three dimensional audio space for corresponding audio sources, and for insertion of local communication and/or commentary in place of audio from an audio source that is inactive.

It should be noted, that access services, such as providing access to games of the current embodiments, delivered over a wide geographical area often use cloud computing. Cloud computing is a style of computing in which dynamically scalable and often virtualized resources are provided as a service over the Internet. For example, cloud computing services often provide common applications (e.g., video games) online that are accessed from a web browser, while the software and data are stored on the servers in the cloud.

A game server may be used to perform operations for video game players playing video games over the internet, in some embodiments. In a multiplayer gaming session, a dedicated server application collects data from players and distributes it to other players. The video game may be executed by a distributed game engine including a plurality of processing entities (PEs) acting as nodes, such that each PE executes a functional segment of a given game engine that the video game runs on. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. The PEs may be virtualized by a hypervisor of a particular server, or the PEs may reside on different server units of a data center. Respective processing entities for performing the operations may be a server unit, a virtual machine, or a container, GPU, CPU, depending on the needs of each game engine segment. By distributing the game engine, the game engine is provided with elastic computing properties that are not bound by the capabilities of a physical server unit. Instead, the game engine, when needed, is provisioned with more or fewer compute nodes to meet the demands of the video game.

Users access the remote services with client devices (e.g., PC, mobile phone, etc.), which include at least a CPU, a display and I/O, and are capable of communicating with the game server. It should be appreciated that a given video game may be developed for a specific platform and an associated controller device. However, when such a game is made available via a game cloud system, the user may be accessing the video game with a different controller device, such as when a user accesses a game designed for a gaming console from a personal computer utilizing a keyboard and mouse. In such a scenario, an input parameter configuration defines a mapping from inputs which can be generated by the user's available controller device to inputs which are acceptable for the execution of the video game.

In another example, a user may access the cloud gaming system via a tablet computing device, a touchscreen smartphone, or other touchscreen driven device, where the client device and the controller device are integrated together, with inputs being provided by way of detected touchscreen inputs/gestures. For such a device, the input parameter configuration may define particular touchscreen inputs corresponding to game inputs for the video game (e.g., buttons, directional pad, gestures or swipes, touch motions, etc.).

In some embodiments, the client device serves as a connection point for a controller device. That is, the controller device communicates via a wireless or wired connection with the client device to transmit inputs from the controller device to the client device. The client device may in turn process these inputs and then transmit input data to the cloud game server via a network. For example, these inputs might include captured video or audio from the game environment that may be processed by the client device before sending to the cloud game server. Additionally, inputs from motion detection hardware of the controller might be processed by the client device in conjunction with captured video to detect the position and motion of the controller before sending to the cloud gaming server.

In other embodiments, the controller can itself be a networked device, with the ability to communicate inputs directly via the network to the cloud game server, without being required to communicate such inputs through the client device first, such that input latency can be reduced. For example, inputs whose detection does not depend on any additional hardware or processing apart from the controller itself can be sent directly from the controller to the cloud game server. Such inputs may include button inputs, joystick inputs, embedded motion detection inputs (e.g., accelerometer, magnetometer, gyroscope), etc.

Access to the cloud gaming network by the client device may be achieved through a network implementing one or more communication technologies. In some embodiments, the network may include 5th Generation (5G) wireless network technology including cellular networks serving small geographical cells. Analog signals representing sounds and images are digitized in the client device and transmitted as a stream of bits. 5G wireless devices in a cell communicate by radio waves with a local antenna array and low power automated transceiver. The local antennas are connected with a telephone network and the Internet by high bandwidth optical fiber or wireless backhaul connection. A mobile device crossing between cells is automatically transferred to the new cell. 5G networks are just one communication network, and embodiments of the disclosure may utilize earlier generation communication networks, as well as later generation wired or wireless technologies that come after 5G.

In one embodiment, the various technical examples can be implemented using a virtual environment via a head-mounted display (HMD), which may also be referred to as a virtual reality (VR) headset. As used herein, the term generally refers to user interaction with a virtual space/environment that involves viewing the virtual space through an HMD in a manner that is responsive in real-time to the movements of the HMD (as controlled by the user) to provide the sensation to the user of being in the virtual space or metaverse. An HMD can be worn in a manner similar to glasses, goggles, or a helmet, and is configured to display a video game or other metaverse content to the user. The HMD can provide a very immersive experience in a virtual environment with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user’s interaction with the VR scenes. For example, while interacting with the scenes in the game, the user may make various gestures (e.g., commands, communications, pointing and walking toward a particular content item in the scene, etc.). In one embodiment, the gestures can be tracked and processed by the system to generate a prediction of interaction with the particular content item in the game scene. In some embodiments, machine learning may be used to facilitate or assist in the prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on an HMD. In some cases, the HMD can be wirelessly connected to a cloud computing and gaming system over a network, such as internet, cellular, etc. In one embodiment, the cloud computing and gaming system maintains and executes the video game being played by the user. In some embodiments, the cloud computing and gaming system is configured to receive inputs from the HMD and/or interfacing objectsover the network. The cloud computing and gaming system is configured to process the inputs to affect the game state of the executing video game. The output from the executing video game, such as video data, audio data, and haptic feedback data, is transmitted to the HMD and the interface objects.

Additionally, though implementations in the present disclosure may be described with reference to n HMD, it will be appreciated that in other implementations, non-HMDs may be substituted, such as, portable device screens (e.g., tablet, smartphone, laptop, etc.) or any other type of display that can be configured to render video and/or provide for display of an interactive scene or virtual environment. It should be understood that the various embodiments defined herein may be combined or assembled into specific implementations using the various features disclosed herein. Thus, the examples provided are just some possible examples, without limitation to the various implementations that are possible by combining the various elements to define many more implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations were described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

With the above embodiments in mind, it should be understood that embodiments of the present disclosure can employ various computer-implemented operations involving data stored in computer systems. These operations are those requiring physical manipulation of physical quantities. Any of the operations described herein in embodiments of the present disclosure are useful machine operations. Embodiments of the disclosure also relate to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server, or by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation maybe produced by an emulator that emulates a processing system.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

What is claimed is:

1. A method, comprising:
defining a three dimensional (3D) audio space having one or more audio sources configured to provide directional audio in the 3D audio space;
receiving gaming audio from a game play of a video game of a player for presentation within the 3D audio space;
assigning one or more source locations in the 3D audio space to the one or more audio sources, wherein each audio source is assigned to a corresponding source location;
projecting audio content from the one or more audio sources, wherein corresponding audio content projected from each of the one or more audio sources is projected from a corresponding source location;
capturing a local audio stream from a communicator located in a same physical space as the player;
determining a period of inactivity for a first audio source of the one or more audio sources, wherein a first corresponding audio content from the first audio source is not projected during the period of inactivity; and
projecting the local audio stream from a first source location in the 3D audio space assigned to the first audio source during the period of inactivity.

2. The method of claim 1, wherein the 3D audio space is defined in relation to a head mounted display (HMD) or a 3D audio system, and wherein the one or more audio sources are spatially separated within the 3D audio space.

3. The method of claim 1, wherein determining the period of inactivity for the first audio source comprises:
determining a current time;
determining, for a period of time leading up to the current time, that the first audio source has not projected the first corresponding audio content;
evaluating the period of time against a threshold; and
determining, responsive to the threshold being satisfied, that the period of time is the period of inactivity.

4. The method of claim 1, further comprising:
determining that the period of inactivity does not exceed a threshold; and
pausing projection of the first corresponding audio content from the first audio source to project the local audio stream based on a priority level of the local audio stream.

5. The method of claim 1, further comprising:
determining a direction from the communicator to the player in the same physical space; and
placing the first source location in the 3D audio space in alignment with the direction from which the local audio stream of the communicator is projected in physical space.

6. The method of claim 1, further comprising providing a notification that the local audio stream will be projected.

7. The method of claim 1, further comprising:
determining that the local audio stream comprises a priority level; and
overriding the first corresponding audio content using the local audio stream and based on the priority level.

8. The method of claim 1, further comprising:
determining that the local audio stream comprises a priority level; and
filtering out the local audio stream based on the priority level, wherein filtering out the local audio stream involves not projecting the local audio stream.

9. A computer system comprising:
a processor; and
memory coupled to the processor and having stored therein instructions that, if executed by the computer system, cause the computer system to execute a method comprising:
defining a three dimensional (3D) audio space having one or more audio sources configured to provide directional audio in the 3D audio space;
receiving gaming audio from a game play of a video game of a player for presentation within the 3D audio space;
assigning one or more source locations in the 3D audio space to the one or more audio sources, wherein each audio source is assigned to a corresponding source location;
projecting audio content from the one or more audio sources, wherein corresponding audio content projected from each of the one or more audio sources is projected from a corresponding source location;
capturing a local audio stream from a communicator located in a same physical space as the player;
determining a period of inactivity for a first audio source of the one or more audio sources, wherein a first corresponding audio content from the first audio source is not projected during the period of inactivity; and
projecting the local audio stream from a first source location in the 3D audio space assigned to the first audio source during the period of inactivity.

10. The computer system of claim 9, wherein the 3D audio space is defined in relation to a head mounted display (HMD) or a 3D audio system, and wherein the one or more audio sources are spatially separated within the 3D audio space.

11. The computer system of claim 9, the method further comprising:
determining a current time;
determining, for a period of time leading up to the current time, that the first audio source has not projected the first corresponding audio content;
evaluating the period of time against a threshold; and
determining, responsive to the threshold being satisfied, that the period of time is the period of inactivity.

12. The computer system of claim 9, the method further comprising:
determining that the period of inactivity does not exceed a threshold; and
pausing projection of the first corresponding audio content from the first audio source to project the local audio stream based on a priority level of the local audio stream.

13. The computer system of claim 9, the method further providing a notification that the local audio stream will be projected.

14. The computer system of claim 9, the method further comprising:
determining that the local audio stream comprises a priority level; and
overriding the first corresponding audio content using the local audio stream and based on the priority level.

15. A non-transitory computer-readable medium storing a computer program for performing a method, the computer-readable medium comprising:
program instructions for defining a three dimensional (3D) audio space having one or more audio sources configured to provide directional audio in the 3D audio space;
program instructions for receiving gaming audio from a game play of a video game of a player for presentation within the 3D audio space;
program instructions for assigning one or more source locations in the 3D audio space to the one or more audio sources, wherein each audio source is assigned to a corresponding source location;
program instructions for projecting audio content from the one or more audio sources, wherein corresponding audio content projected from each of the one or more audio sources is projected from a corresponding source location;
program instructions for capturing a local audio stream from a communicator located in a same physical space as the player;
program instructions for determining a period of inactivity for a first audio source of the one or more audio sources, wherein a first corresponding audio content from the first audio source is not projected during the period of inactivity; and
program instructions for projecting the local audio stream from a first source location in the 3D audio space assigned to the first audio source during the period of inactivity.

16. The non-transitory computer-readable medium of claim 15, wherein the 3D audio space is defined in relation to a head mounted display (HMD) or a 3D audio system, and wherein the one or more audio sources are spatially separated within the 3D audio space.

17. The non-transitory computer-readable medium of claim 15, further comprising:
program instructions for determining a current time;
program instructions for determining, for a period of time leading up to the current time, that the first audio source has not projected the first corresponding audio content;
program instructions for evaluating the period of time against a threshold; and
program instructions for determining, responsive to the threshold being satisfied, that the period of time is the period of inactivity.

18. The non-transitory computer-readable medium of claim 15, further comprising:
program instructions for determining that the period of inactivity does not exceed a threshold; and
program instructions for pausing projection of the first corresponding audio content from the first audio source to project the local audio stream based on a priority level of the local audio stream.

19. The non-transitory computer-readable medium of claim 15, further comprising program instructions for providing a notification that the local audio stream will be projected.

20. The non-transitory computer-readable medium of claim 15, further comprising:
program instructions for determining that the local audio stream comprises a priority level; and
overriding the first corresponding audio content using the local audio stream and based on the priority level.
